(19) United States
(12) Patent Application Publication
(10) Pub. No.: US 2009/0184450 A1
(43) Pub. Date: Jul. 23, 2009

(54) Automatic workpiece clamp and support

(76) Inventor: Matthew Wayne Wuerthner, Odenton, MD (US)

Correspondence Address: JAMES A. KODAK, 2626 BARRED OWL WAY, ODENTON, MD, 21113, US

(21) Appl. No.: 12/015,954

(22) Filed: Jan. 17, 2008

(51) Int. Cl. B25B 5/06; B23Q 3/06; B25B 11/00

(52) U.S. Cl. 269/133; 269/157; 269/285

(57) ABSTRACT

An automatic clamping device is disclosed for holding planar workpieces such as: doors, windows, panels, plasterboard, etc. The planar workpiece is held in an upright position by clamping jaws actuated by the weight of the workpiece. Automatic clamping is accomplished by placing the workpiece through a slot at the top of the clamping device and lowering it onto a flexible strap connected to movable jaws which, under the weight of the workpiece, move laterally towards and clamp the workpiece. The workpiece is released by simply lifting it up through the slot and coil springs will automatically return the jaws to an open position. The device also provides support for holding planar workpieces on an incline.

### BACKGROUND OF THE INVENTION

1. Field of the Invention

The invention relates generally to the quick engagement of planar workpieces in a steady upright position while work is done upon them and more specifically to the quick engagement and disengagement of a door, window, or plasterboard as such an objects is cut, trimmed, painted or prepared for lock and hinge installation.

2. Description of the Prior Art

There are numerous devices in the field of door holders and clamps dating back to the nineteenth century. These devices can be separated into two basic mechanisms. One type of mechanism uses a brace or a plurality of braces to hold the door or other planar piece on edge and the positioning of the braces is secured by either a wedge (U.S. Pat. No. 7,125,009), a screw (e.g. U.S. Pat. No. 6,886,821), a pin (e.g. U.S. Pat. No. 5,294,099), a retractable spring (e.g. U.S. Pat. No. 4,391,437), or fixed ridges (e.g. U.S. Pat. No. 2,621,687). Another type uses the weight of the workpiece itself in order to actuate stabilizing braces or jaws. U.S. Pat. No. 5,513,836, U.S. Pat. No. 4,799,658, U.S. Pat. No. 4,270,741, U.S. Pat. No. 2,971,548 and U.S. Pat. No. 2,605,795 all disclose a holding mechanism actuated by the weight of the workpiece.

Although this latter type of mechanism permits automatic clamping, all such devices employing it to date are composed of numerous parts and contain several points of friction between the receiver and the clamping mechanism. There is thus a need in the art for a simple, inexpensive and maintenance free way to quickly secure planar workpieces.

### SUMMARY OF THE INVENTION

The present invention serves the dual purpose of automatically clamping a planar workpiece in an upright position and providing a practical support means for keeping a workpiece at an incline position for work on its broad side.

The invention has an open slot at the top through which a planar workpiece is inserted. As the workpiece is lowered, it engages a flexible strap which is attached on either end to rigid bars with a substantially square cross-section. These rigid bars serve as clamping jaws. The weight of the workpiece forces the clamping jaws together, overcoming the force of a spring or other elastic mechanism that keeps the jaws separate when no workpiece is engaged. The spring mechanism keeps the clamping jaws separated in an open position via rotating levers that are attached to the spring, the frame and the top portions of the clamping jaws. On the lower portions of the clamping jaws there are pivoting arms which attach to the frame portion of the invention. As these pivoting arms are rigid with respect to any horizontal movement perpendicular to the clamping motion, they serve as an effective means of preventing the clamping jaws from swinging while engaged.

All parts comprising the top of the invention are beveled so that it may be used to hold the broad side of a workpiece at an acute angle with respect to the ground. Upon the placement of a sufficiently heavy workpiece, such as a door, on top of the invention, the weight of the workpiece forces the top levers down into a position that is parallel to the ground. All top portions are beveled so that when the levers swing to this parallel position they form a continuous smooth angle allowing for stable support of a door when laid at a sufficiently acute angle with respect to the ground.

To prevent the invention from falling over while in use, it is equipped with a rotating leg piece that swings out laterally on both sides of the frame base.

### BRIEF DESCRIPTION OF THE DRAWINGS

An embodiment of the present invention will now be described by way of an example and with reference to the accompanying drawings, in which:

FIG. 1 illustrates a front view of the clamp/support embodying the present invention in a state of non-use.

FIG. 2 illustrates a top view of a planar workpiece held upright by the clamp/support of FIG. 1; and

FIG. 3 illustrates a side view of a planar workpiece kept at an angle with the clamp/support of FIG. 1.

### DETAILED DESCRIPTION

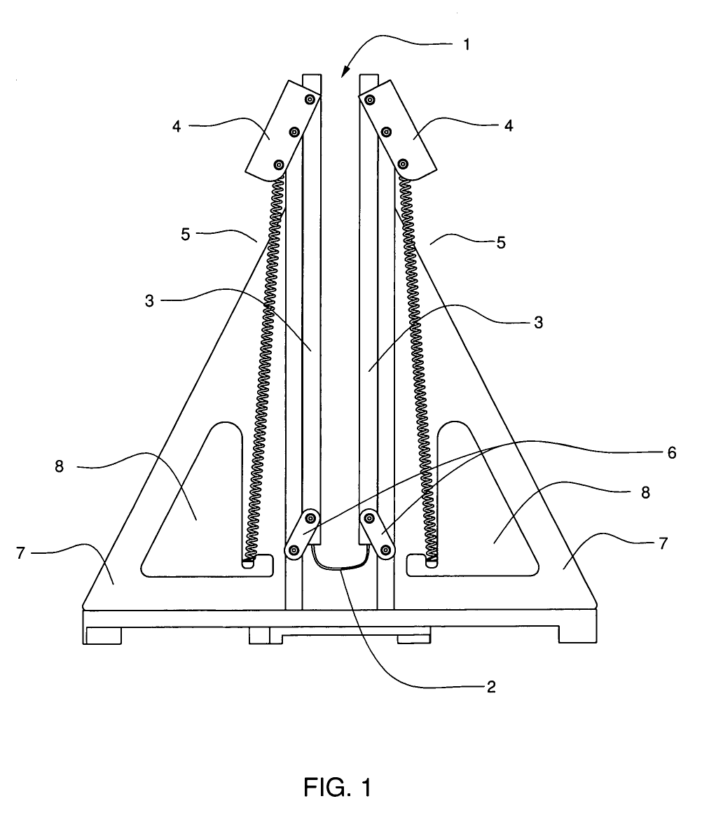

Before engagement with a workpiece, as shown in FIG. 1, the clamping jaws 3 are pressed against the frame 7 by springs or other elastic members 5 which are connected to the clamping jaws 3 via rotating levers 4 that are secured to the frame 7. The point at which the levers 4 join the frame 7 defines the pivot point for the levers. Before engagement, there is a gap 1 between the clamping jaws 3 into which a door, panel, window, plasterboard, or other workpiece can be inserted. The overall shape of the frame 7 is generally triangular and gap 1 essentially creates two symmetrical triangles on either side of the gap. Assuming the invention is composed of a sufficiently sturdy material such as wood, the centers of these two symmetrical triangles may be cut out 8 while preserving physical integrity. These cut outs 8 serve not only to lessen the overall weight of the invention, but also provide a simple and effective means for gripping it.

The design of the clamping jaws is critical to the utility of this invention. The preferred embodiment employs elongated bars with a square cross section. Since it is envisioned that most workpieces will be made of wood, friction will be maximized if the clamping jaws are also made of wood. In the alternative, the side of the jaw that engages the workpiece can be coated or covered with a tacky surface specifically designed for gripping materials made of wood.

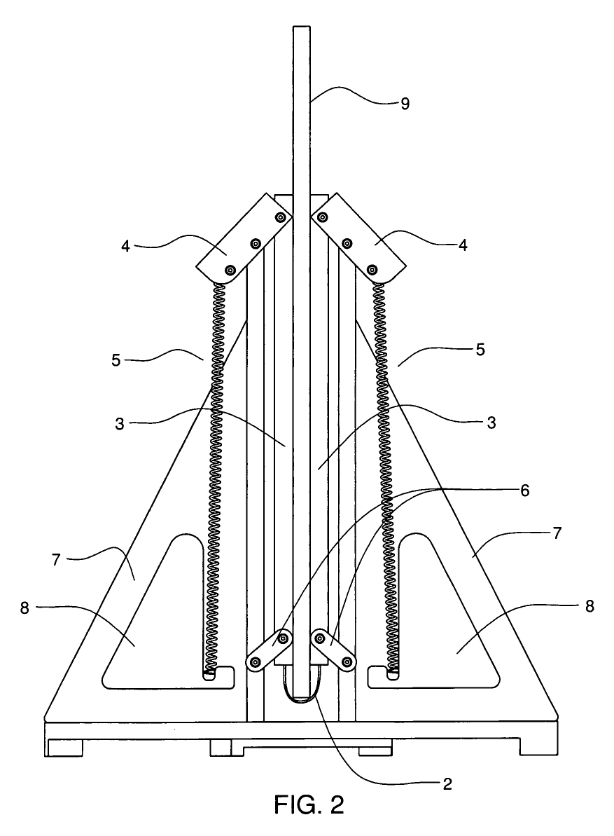

When the clamp is engaged with a workpiece 9, as shown in FIG. 2, the weight of the workpiece presses down upon the catch strap 2. The catch strap 2, with ends attached to the bottom of the clamping jaws 3, forces the clamping jaws 3 inward, overcoming the resistance of the springs 5, until the clamping jaws 3 engage the workpiece 9. Pivoting arms 6, mounted near the bottom of the clamping jaws 3, prevent any swinging motion perpendicular to the frame 7. The pivoting arms 6 are attached at one end to the clamping jaws 3 and to the frame 7 at the other end.

Although the catch strap can be attached to the bottom of the clamping jaws in any number of ways, it is preferable that the strap form an eye at both ends that is suitable for wrapping around a dowel. The bottoms of the clamping jaws are then mortised to receive the strap and dowel. To secure the joint from any slippage, glue should be applied to both the dowel and the strap before sliding into the mortise.

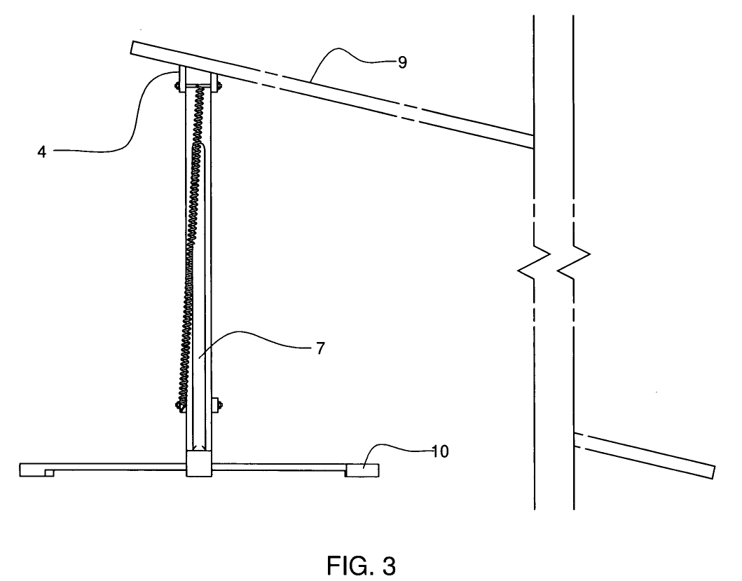

The levers 4 at the top of the invention can serve as a means of stabilizing a planar workpiece lain upon its broadside, FIG. 3. When a workpiece 9 is placed upon the top, the levers 4 will flatten under its weight. The tops of the levers 4 are beveled at an appropriate angle so as to maximize surface contact with the workpiece 9, preferably between 10° and 15°. The preferred angle is calculated based upon a few practical assumptions: (1) the work piece will most often be a door, (2) a door will lay lengthwise with one end on the floor and the other end on or just beyond the support, and (3) the height of the average door is approximately 2 meters.

Whether the invention is being employed in its clamp or in its support capacity, it is necessary to prevent it from falling down in a direction parallel to the length of the work piece 9, FIG. 3. This lateral support will be provided by a leg piece 10. In order to simplify the storage of the workpiece clamp and support, it is preferable for the leg piece 10 to be in line with the base of frame 7 when not in use and then rotate away from the base when the clamp or support is put to use. This can be accomplished by mounting the center of the leg piece 10 with the center of the frame 7, but in such a way as to allow rotation of the leg piece, e.g., a shoulder bolt mount.

I claim:

1. A clamping device for holding generally planar workpieces in an upright position comprising:
two bars with a generally square cross-section that serve to clamp a planar workpiece such as a door, panel, window, or plasterboard in an upright position;
at least one of said bars can move perpendicular to the plane of said workpiece;
the force of clamping is generated by the weight of said workpiece;
the weight of said workpiece generates clamping via utilization of a flexible catch strap which is attached to the bottom of said bars; and
a starting gap in between said bars so as to permit said workpiece to easily slide therein and engage said flexible catch strap.

2. A clamping device for holding generally planar workpieces in an upright position comprising:
two bars with a generally square cross-section that serve to clamp a planar workpiece such as a door, panel, window, or plasterboard in an upright position;
at least one of said bars can move perpendicular to the plane of said workpiece;
the force of clamping is generated by the weight of said workpiece;
the weight of said workpiece generates clamping via utilization of a catch strap which is attached to the bottom of said bars;
a starting gap in between said bars so as to permit said workpiece to easily slide therein and engage said catch strap; and
springs or other elastic means generate the force necessary to hold said bars apart when said flexible catch strap is not engaged with said workpiece.

3. A clamping device for holding generally planar workpieces in an upright position comprising:
two bars with a generally square cross-section that serve to clamp a planar workpiece such as a door, panel, window, or plasterboard in an upright position;
at least one of said bars can move perpendicular to the plane of said workpiece;
the force of clamping is generated by the weight of said workpiece;
the weight of said workpiece generates clamping via utilization of a catch strap which is attached to the bottom of said bars;
a starting gap in between said bars so as to permit said workpiece to easily slide therein and engage said catch strap;
springs or other elastic means generate the force necessary to hold said bars apart when said flexible catch strap is not engaged with said workpiece; and
top portions of said clamping device beveled to form one continuous angle with respect to the ground between 10° and 15°.

4. A clamping device as defined in claim 1 wherein the bottom of said bars are stabilized by levers attached to the bar at one end and the frame of said clamping device on the other and these attachments are rigid in the direction parallel to the plane of said workpiece but allow free rotation in the plane perpendicular to said workpiece.

5. A clamping device as defined in claim 1 wherein the surface of said bars are coated with a high friction material such as rubber.

6. A clamping device as defined in claim 1 wherein said bars are attached to said springs or other elastic means via rotating levers situated at the top of said clamping device and these levers, actuated by the weight of a workpiece lain on its side, flatten to form a continuous angle with respect to the ground between 10° and 15°.

7. A clamping device as defined in claim 1 wherein a leg piece is secured to the base of said clamping device and said leg piece swings out in both directions lateral to the plane of said clamping device.

8. A clamping device as defined in claim 1 wherein the frame of said clamping device possesses at least one cut out portion of sufficient area so as to accommodate the grip of an adult human hand.

9. A clamping device as defined in claim 2 wherein the bottom of said bars are stabilized by levers attached to the bar at one end and the frame of said clamping device on the other and these attachments are rigid in the direction parallel to the plane of said workpiece but allow free rotation in the plane perpendicular to said workpiece.

10. A clamping device as defined in claim 2 wherein the surface of said bars are coated with a high friction material such as rubber.

11. A clamping device as defined in claim 2 wherein said bars are attached to said springs or other elastic means via rotating levers situated at the top of said clamping device and these levers, actuated by the weight of a workpiece lain on its side, flatten to form a continuous angle with respect to the ground between 10° and 15°.

12. A clamping device as defined in claim 2 wherein a leg piece is secured to the base of said clamping device and said leg piece swings out in both directions lateral to the plane of said clamping device.

13. A clamping device as defined in claim 2 wherein the frame of said clamping device possesses at least one cut out portion of sufficient area so as to accommodate the grip of an adult human hand.

14. A clamping device as defined in claim 3 wherein the bottom of said bars are stabilized by levers attached to the bar at one end and the frame of said clamping device on the other and these attachments are rigid in the direction parallel to the plane of said workpiece but allow free rotation in the plane perpendicular to said workpiece.

15. A clamping device as defined in claim 3 wherein the surface of said bars are coated with a high friction material such as rubber.

16. A clamping device as defined in claim 3 wherein said bars are attached to said springs or other elastic means via rotating levers situated at the top of said clamping device and these levers, actuated by the weight of a workpiece lain on its side, flatten to form a continuous angle with respect to the ground between 10° and 15°.

17. A clamping device as defined in claim 3 wherein a leg piece is secured to the base of said clamping device and said leg piece swings out in both directions lateral to the plane of said clamping device.

18. A clamping device as defined in claim 3 wherein the frame of said clamping device possesses at least one cut out portion of sufficient area so as to accommodate the grip of an adult human hand.
